(19) United States
(12) Patent Application Publication
(10) Pub. No.: US 2008/0027681 A1
(43) Pub. Date: Jan. 31, 2008

(54) Method For Predictive Maintenance Of An Operating Component Of An Automatic Machine

(76) Inventor: Francesco Nicastro, Imola (IT)

Correspondence Address: OSTROLENK FABER GERB & SOFFEN, 1180 AVENUE OF THE AMERICAS, NEW YORK, NY, 100368403, US

(21) Appl. No.: 10/580,627

(22) PCT Filed: Nov. 23, 2004
(86) PCT No.: PCT/EP04/53057

§ 371 Date: Jul. 31, 2007

(30) Foreign Application Priority Data
Nov. 24, 2003 (IT) B02003A 000711

(51) Int. Cl. G06F 17/40

(52) U.S. Cl. 702/184

(57) ABSTRACT

A method for predictive maintenance of an operating component of an automatic machine, which method acquires at least two values, each relative to a respective characteristic quantity of the operating component, compares each value with a threshold value, and determines a specific defect and programs maintenance as a function of the comparison between the values and the threshold values.

### TECHNICAL FIELD

The present invention relates to a method for predictive maintenance of an operating component of an automatic machine.

The present invention may be used to advantage on automatic machines employed in the tobacco industry, to which the following description refers purely by way of example.

### BACKGROUND ART

An automatic machine comprises a number of operating components (e.g. bearings, fans, drives, motors), each of which performs a given function and is subject to malfunctions which frequently require stopping the machine to adjust or replace the component. Machine stoppages mean production hold-ups and, therefore, reduced profit on the part of the manufacturer.

To reduce the cost of production hold-ups, it is common practice to perform routine maintenance, and in particular to adjust or replace each operating component at given intervals determined experimentally. Particularly in the case of complex automatic machines such as those used in the tobacco industry, however, the above method has been found to result in two extreme situations, depending on the selected maintenance intervals: high average breakdown frequency, thus resulting in increased cost through loss of production; or excessively frequent maintenance, thus resulting in increased maintenance cost.

Determining the right maintenance interval has always been difficult, on account of dispersion and drift in the construction and operating characteristics of each operating component. Also, breakdown frequency has been found to depend closely on the working environment (e.g. temperature or humidity) and on the type of product manufactured (in particular, the type of material used).

U.S. Pat. No. 6,330,525 discloses a method for diagnosing a pump system according to which one or more measured values are acquired. A defect can be identified as a function of the comparison of a single measured value with an original reference value.

The method disclosed in U.S. Pat. No. 6,330,525 has several drawbacks: inter alia such a method cannot determine complex defects (i.e. defects which cannot be determined on the basis of one measurement) and has a relatively low reliability, since a wrong defect (i.e. something which is not really responsible for the malfunctioning) is relatively often identified.

### DISCLOSURE OF INVENTION

It is an object of the present invention to provide a method for predicting maintenance of an operating component of an automatic machine, designed to eliminate or reduce the aforementioned drawbacks, and which, in particular, is cheap and easy to implement.

According to the present invention, there is provided a method for predicting maintenance of an operating component of an automatic machine, as claimed in claim 1 and, preferably, in any one of the following Claims depending directly or indirectly on claim 1.

### BRIEF DESCRIPTION OF THE DRAWINGS

A number of non-limiting embodiments of the present invention will be described by way of example with reference to the accompanying drawings, in which:

FIG. 1 shows a schematic, partly sectioned, plan view, with parts removed for clarity, of a number of operating components of an automatic machine, to which a predictive maintenance method in accordance with the present invention is applied;

FIG. 2 shows a section along line II-II of part of an operating component in FIG. 1;

FIGS. 3 and 4 show diagrams of how data relative to the operating components in FIG. 1 is used in the predictive maintenance method according to the present invention;

FIG. 5 shows a graph of vibration frequencies determined applying a predictive maintenance method in accordance with the present invention;

FIG. 6 shows a time graph of characteristic quantities of operating components of an automatic machine to which a predictive maintenance method in accordance with the present invention is applied.

### BEST MODE FOR CARRYING OUT THE INVENTION

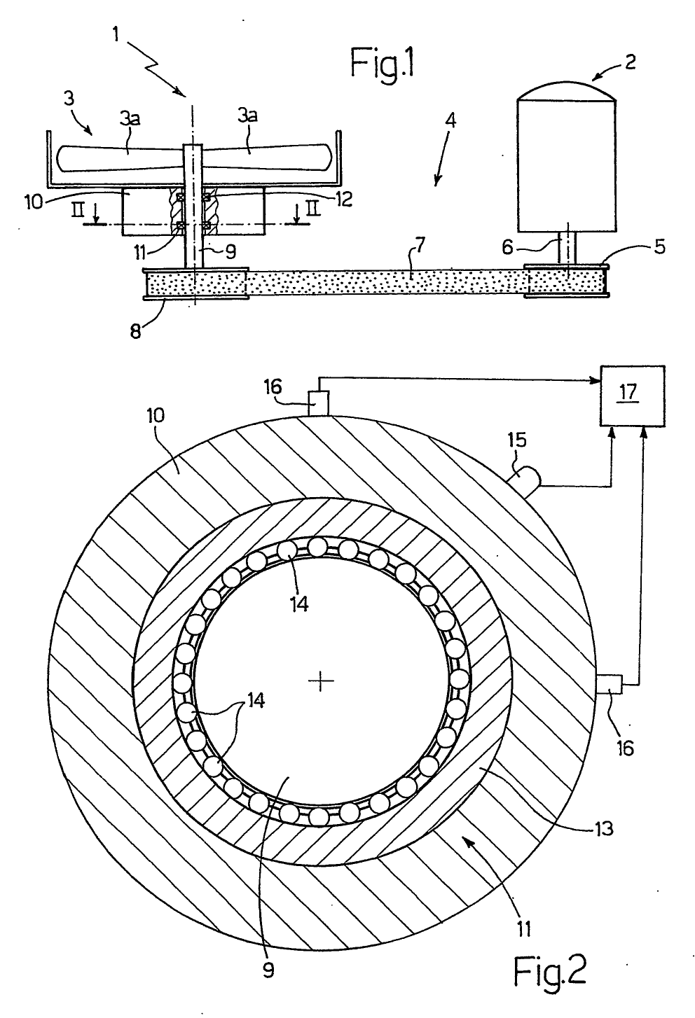

Number 1 in FIG. 1 indicates as a whole a fan unit of an automatic machine (not shown). Fan unit 1 comprises an electric motor 2, a fan 3, and a connecting unit 4 for transferring power from motor 2 to fan 3.

Connecting unit 4 comprises a drive pulley 5 integral with an output shaft 6 of motor 2; and a belt 7 looped about pulley 5 and about a pulley 8 connected integrally to a shaft 9 of fan 3. Fan 3 also comprises a number of blades 3a fitted to the opposite end of shaft 9 to pulley 8.

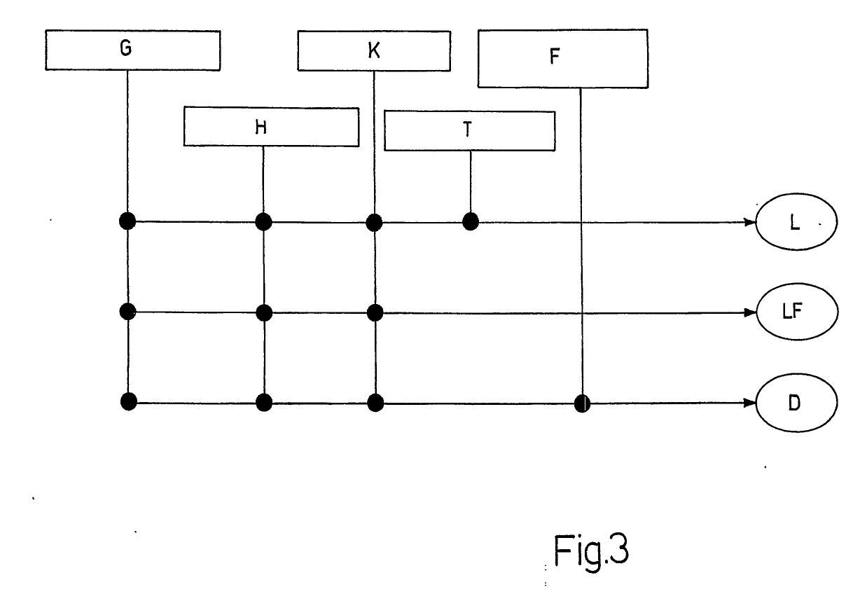

Unit 1 also comprises a tubular support 10 housing two radial bearings 11 and 12, which support shaft 9 for rotation about a respective longitudinal axis of rotation. As shown in FIG. 2, each bearing 11, 12 comprises an outer ring 13 connected rigidly to support 10; and a number of rotating elements 14, in particular, balls, located between outer ring 13 and shaft 9.

The outer surface of support 10 is fitted, at bearing 11, with a temperature sensor 15; and two sensors 16 oriented radially with respect to support 10 and at 90° with respect to each other, and which provide for measuring vibrational energy at different vibration frequencies. Temperature sensor 15 and both sensors 16 are connected to a control unit 17. It is important to note that the particularly arrangement of sensors 16 provides for detecting any vibration propagating radially from shaft 9.

In one embodiment, in addition to sensors 16, unit 1 also comprises a further known vibration sensor (not shown) for determining any vibration propagating longitudinally with respect to shaft 9.

In actual use, control unit 17 collects the measurements made by sensors 15 and 16, and processes them to obtain values V, which are compared with reference data to determine a specific defect and program maintenance to correct the defect, so that the machine (not shown) can be kept running as along as possible, before the defect begins to impair operation of unit 1.

In one embodiment, each measurement is processed to obtain a respective value V directly proportional to the relative measurement; each value V is compared with a respective reference data threshold value; and the defect of unit 1 is determined as a function of the combination of the differences between each value V and the respective threshold value.

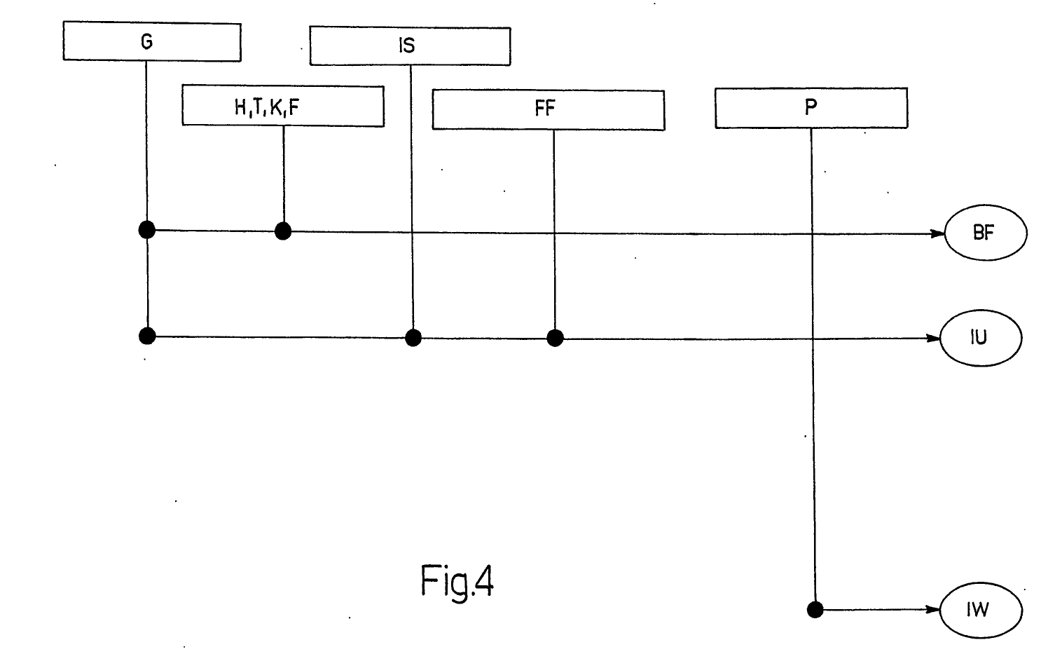

More specifically, with reference to FIG. 3, to monitor bearing 11, the following characteristic quantities of bearing 11 are measured:
temperature T of bearing 11;
total vibrational energy G;
vibrational energy at 6-10 kHz frequencies H;
vibration kurtosis K;
vibrational energy at given frequencies F typical of damage to bearing 11.

Given frequencies typical of damage to bearing 11 are intended to mean, in particular, frequencies FE typical of damage to outer ring 13; frequencies FR typical of damage to a rotating element 14; and/or frequencies FI typical of damage to shaft 9 at bearing 11.

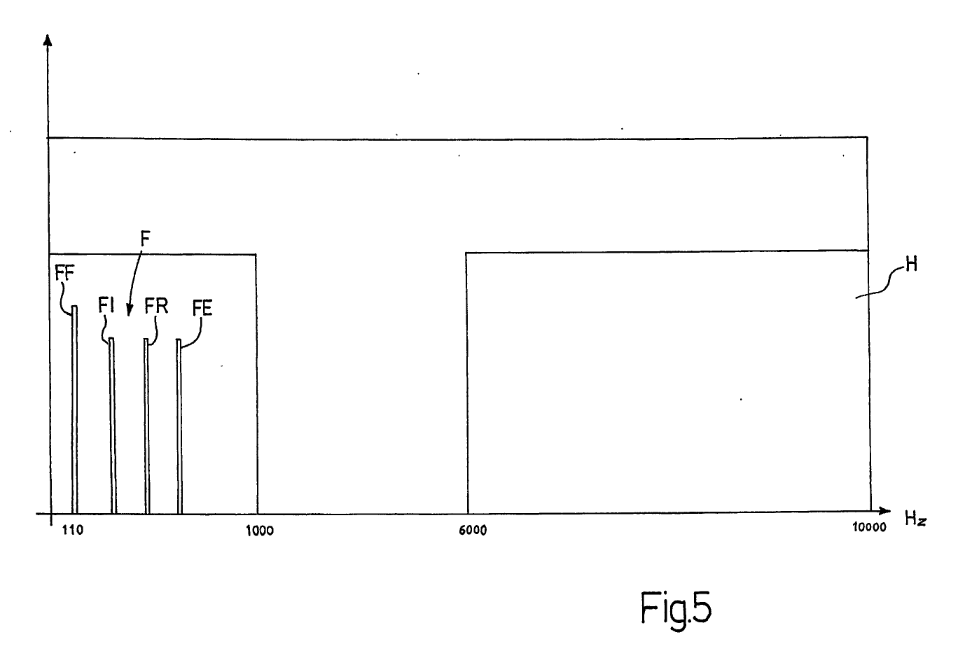

The FIG. 5 graph shows an example of the relationship between different vibration frequencies.

With reference to FIG. 3, when values V of temperature T, total vibrational energy G, vibrational energy at 6-10 kHz frequencies H, and vibration kurtosis K exceed the respective threshold values, and value V of vibrational energy at given frequencies F is below the respective threshold value, a defect L is determined, caused by poor lubrication of bearing 11. When values V of total vibrational energy G, vibrational energy at 6-10 kHz frequencies H, and vibrational kurtosis K exceed the respective threshold values, and values V of vibrational energy at given frequencies F, and temperature T are below the respective threshold values, a defect LF is determined, caused by a loose connection between bearing 11 and support 10. When values V of total vibrational energy G, vibrational energy at 6-10 kHz frequencies H, vibrational energy at given frequencies F, and vibration kurtosis K exceed the respective threshold values, and value V of temperature T is below the respective threshold value, a defect D is determined, caused by damage to bearing 11.

This is shown schematically in FIG. 3, in which the symbol “•” indicates a characteristic quantity value V exceeding the respective threshold value.

In other words, a defect is identified as a function of the combination of at least two comparison: a comparison between a first measured value V and reference data and a further comparison between a second measured value V and reference data.

In a further embodiment, in addition to or instead of the above embodiment, each measurement is processed to obtain a respective value V, and the values V are combined to obtain one or more combinations of values V; each combination is compared with a respective threshold value; and the defect of bearing 11 is determined as a function of the difference between each combination and the respective threshold value.

In alternative embodiments, as opposed to being directly proportional to the respective measurement, at least one of values V is a function of the time pattern of the respective measurement.

Control unit 17 also provides for programming maintenance of bearing 11.

In one embodiment, experimental curves are determined, each of which extrapolates the time pattern of a respective value V. In which case, maintenance is programmed as a function of the instants in which one or more experimental curves intercept respective reference curves. More specifically, maintenance may be programmed to be carried out either at the exact instant, or within a given time interval before or after the instant, in which an experimental curve intercepts the respective reference curve.

In a further embodiment, in addition to or instead of the above embodiment, values V are combined to obtain one or more combinations of values V; experimental curves of the combinations are determined, each of which extrapolates the time pattern of a respective combination of values; and maintenance is programmed as a function of the instants in which one or more experimental curves of the combinations intercept respective reference data reference curves. More specifically, maintenance may be programmed to be carried out either at the exact instant, or within a given time interval before or after the instant, in which an experimental curve of a combination intercepts the respective reference curve.

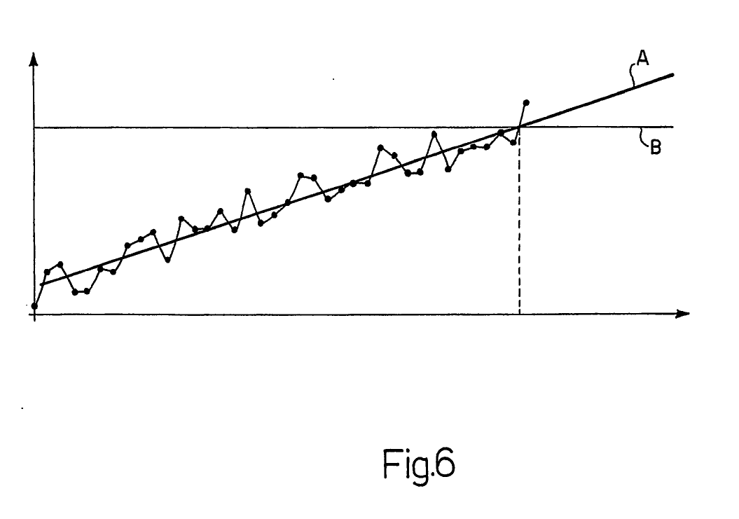

Purely by way of example, FIG. 6 shows a graph of an experimental curve, in which time is shown along the x axis, values V or combinations of values V are shown along the y axis, A indicates an experimental curve, and B a reference curve.

As shown in FIG. 6, preferably, the experimental curves are linear, and each reference curves define a respective constant value.

What has been said above relative to determining defects and programming maintenance of bearing 11 also applies to fan 3. In this case, it is important to bear in mind that defects of fan 3 also comprise defects of bearing 11, which may be determined as described above.

In this case (FIG. 4), the following characteristic quantities are measured:
total vibrational energy G;
vibrational energy at 110-1000 Hz frequencies IS;
vibrational energy at basic machine frequency FF;
suction pressure P of fan 3;
temperature T of bearing 11;
vibrational energy at 6-10 kHz frequencies H;
vibration kurtosis K;
vibrational energy at given frequencies F typical of damage to the bearing.

The suction pressure P of fan 3 is determined by a known sensor (not shown) fitted to fan 3 and connected to control unit 17.

It is important to note that all the characteristic quantities of bearing 11 are measured to determine a defect BF of bearing 11.

As shown in FIG. 4, a defect IU caused by poor balance of fan 3, and/or a defect IW caused by wear of fan 3, can also be determined.

The proposed method therefore provides, in a relatively simple manner, for determining complex defects, i.e. defects which cannot be determined on the basis of one measurement, and at the same time for programming maintenance.

Moreover, with comparison to the known state of the art (e.g. U.S. Pat. No. 6,330,5259) the proposed method has a relatively high reliability as the combination of comparisons of more measurements with reference data provide a relatively deep, and then reliable, knowledge of the operating conditions of an operating component of an automatic machine.

Downtime of the machine due to component breakdown or to routine maintenance is thus reduced, and a precise indication is given of the parts actually requiring maintenance.

1) A method for predictive maintenance of an operating component (3; 11) of an automatic machine; the method acquiring a first and a second measurement relative to a first and, respectively, a second characteristic quantity of the operating component (3; 11), obtaining a first and a second value (V) which are functions of the first and, respectively, second measurement, and to compare the first and second value (V) with given reference data; the method being characterized by determining a specific defect of the operating component (3; 11) as a function of a combination of a comparison between the first value (V) and the given reference data with a comparison between the second value (V) and the given reference data, and/or as a function of a comparison between the given reference data and a combination of said first and second value (V); and programming maintenance to correct said defect, as a function of the combination of the comparison between the first value (V) and the given reference data with the comparison between the second value (V) and the given reference data, and/or as a function of the comparison between the given reference data and the combination of said first and second value (V).

2) A method as claimed in claim 1, wherein the given reference data comprises a first and a second threshold value; said first value (V) being compared with the first threshold value, and the second value (V) being compared with the second threshold value; and the specific defect of the operating component being determined as a function of the difference between the first value (V) and the first threshold value, and of the difference between the second value (V) and the second threshold value.

3) A method as claimed in claim 1, wherein the given reference data comprises a third threshold value; the combination of the first and second value (V) being compared with the third threshold value; and the specific defect of the operating component being determined as a function of the difference between the third threshold value and the combination of the first and second value (V).

4) A method as claimed in claim 1, wherein the first value (V) is a function of the time pattern of the first measurement; the second value (V) being a function of the time pattern of the second measurement.

5) A method as claimed in claim 1, wherein a first experimental curve, which extrapolates the time pattern of the first value (V), is determined, and a second experimental curve, which extrapolates the time pattern of the second value (V), is determined; the given reference data comprising a first and a second reference curve, which are functions of time; and the method programming maintenance as a function of the instant in which the first and/or second experimental curve intercept the first and second reference curve respectively.

6) A method as claimed in claim 5, wherein the first and second experimental curve are linear curves.

7) A method as claimed in claim 5, wherein the first and second reference curve each define a respective constant reference value.

8) A method as claimed in claim 1, wherein a third experimental curve, which extrapolates the time pattern of the combination of the first and second value, is determined; the given reference data comprising a third reference curve which is a function of time; and the method programming maintenance as a function of the instant in which the third experimental curve intercepts the third reference curve.

9) A method as claimed in claim 8, wherein the third experimental curve is a linear curve.

10) A method as claimed in claim 8, wherein the third reference curve defines a constant reference value.

11) A method as claimed in claim 1, wherein the operating component (3; comprises a bearing (11); the first and second characteristic quantity being characteristic quantities of the bearing (11), and being selected from the group consisting in:
temperature (T) of the bearing (11);
total vibrational energy (G);
vibrational energy at kHz frequencies (H);
vibration kurtosis (K);
vibrational energy at given frequencies (F) typical of damage to the bearing.

12) A method as claimed in claim 11, wherein the bearing (11) comprises an outer ring (13) mounted coaxially with a rotary shaft (9) and a number of rotating elements (14), in particular, balls, located between the outer ring (13) and the rotary shaft (9); the given frequencies being selected from the group consisting in:
frequencies (FE) typical of damage to the outer ring (13)
frequencies (FR) typical of damage to a rotating element (14);
frequencies (FI) typical of damage to the rotary shaft (9) at the bearing.

13) A method as claimed in claim 11, wherein the bearing (11) is mounted coaxially with a rotary shaft (9); vibrational energy being determined by two sensors (16) oriented radially with respect to the rotary shaft (9) an at a 90° angle with respect to each other.

14) A method as claimed in claim 11, wherein measurements are acquired of at least each of the following quantities: temperature (T) of the bearing (11), total vibrational energy (G), vibrational energy at 6-10 kHz frequencies (H), vibration kurtosis (K), and vibrational energy at given frequencies (F); the method obtaining a respective value (V) as a function of each measurement.

15) A method as claimed in claim 14, wherein each value (V) is compared with a respective threshold value.

16) A method as claimed in claim 15, wherein a defect (L), caused by poor lubrication, is determined when the values (V) relative to the temperature (T) of the bearing (11), to total vibrational energy (G), to vibrational energy at 6-10 kHz frequencies (H), and to vibrational kurtosis (K) exceed the respective threshold values, and when the value relative to vibrational energy at given frequencies (F) is below the respective threshold value.

17) A method as claimed in claim 15, wherein the bearing (11) is fitted to a support (10); a defect (LF), caused by a loose connection between the bearing (11) and support (10), being determined when the values (V) relative to total vibrational energy (G), to vibrational energy at 6-10 kHz frequencies (H), and to vibrational kurtosis (K) exceed the respective threshold values, and when the values (V) relative to vibration energy at given frequencies (F), and to the temperature (T) of the bearing (11) are below the respective threshold values.

18) A method as claimed in claim 11, wherein a defect (D), caused by damage to the bearing (11), is determined when the values (V) relative to total vibrational energy (G), to vibrational energy at 6-10 kHz frequencies (H), to vibrational energy at given frequencies (F), and to vibration kurtosis (K) exceed the respective threshold values, and when the value relative to the temperature (T) of the bearing (11) is below the respective threshold value.

19) A method as claimed in claim 1, wherein the operating component (3; 11) comprises a fan (3) integral with a shaft (9) rotating on at least one radial bearing (11); the method acquiring measurements of at least two quantities selected from the group comprising:
total vibrational energy (G);
vibrational energy at 110-1000 Hz frequencies (IS);
vibrational energy at the basic frequency (FF) of the machine;
suction pressure (P) of the fan;
temperature (T) of the bearing (11);
vibrational energy at 6-10 kHz frequencies (H);
vibration kurtosis (K);
vibrational energy at given frequencies (F) typical of damage to the bearing;
the method obtaining a respective value (V) as a function of each measurement.

20) A method as claimed in claim 19, wherein measurements are acquired relative to at least each of the following quantities:
total vibrational energy (G);
vibrational energy at 110-1000 Hz frequencies (IS);
vibrational energy at the basic frequency (FF) of the machine;
suction pressure (P) of the fan;
temperature (T) of the bearing (11);
vibrational energy at 6-10 kHz frequencies (H);
vibration kurtosis (K);
vibrational energy at given frequencies (F) typical of damage to the bearing;
the method obtaining a respective value (V) as a function of each measurement.

21) A method as claimed in claim 19, wherein each value is compared with a respective threshold value.
